(19) United States
(12) Patent Application Publication
(10) Pub. No.: US 2022/0355490 A1
(43) Pub. Date: Nov. 10, 2022

(54) CONTROL DEVICE, CONTROL METHOD, AND PROGRAM

(71) Applicant: SONY GROUP CORPORATION, TOKYO (JP)

(72) Inventor: YASUHIRO MATSUDA, TOKYO (JP)

(21) Appl. No.: 17/620,439

(22) PCT Filed: Jun. 15, 2020
(86) PCT No.: PCT/JP2020/023350

§ 371 Date: Dec. 17, 2021

(30) Foreign Application Priority Data
Jun. 26, 2019 (JP) 2019-118634

(51) Int. Cl. B25J 13/08; B25J 9/16; B25J 19/02

(52) U.S. Cl. CPC B25J 13/082; B25J 9/1612; B25J 9/1651; B25J 9/161; B25J 9/163; B25J 19/023

(57) ABSTRACT

The present technology relates to a control device, a control method, and a program capable of enabling predetermined motion while a gripped object is stabilized. A control device according to one aspect of the present technology is a device that detects a gripped state of an object gripped by a hand unit, and limits motion of a motion unit while the object is gripped by the hand unit, in accordance with a result of detection of the gripped state. The present technology can be applied to a device that controls a robot including a hand unit capable of gripping an object.

### TECHNICAL FIELD

The present technology relates particularly to a control device, a control method, and a program capable of enabling a predetermined motion while a gripped object is stabilized.

### BACKGROUND ART

In a case where a robot that operates in an environment in which humans exist lifts an object up or transports an object, it might be better to change the specifics of the motion in accordance with the characteristics of the object, so as to ensure safety or the like.

For example, in a case where a heavy object is moved, it is better not to move the object1 at an excessively high velocity/acceleration, so as to prevent the object from falling. Also, in a case where an object containing liquid is moved, it is better not to move the object at an excessively high speed/acceleration, so as to prevent spilling.

For example, Patent Document 1 discloses a technique for reducing vibration by estimating the weight of an object and changing the load model.

### CITATION LIST

### Patent Documents

Patent Document 1: Japanese Patent Application Laid-Open No. 2017-56525
Patent Document 2: Japanese Patent Application Laid-Open No. 2016-20015
Patent Document 3: Japanese Patent Application Laid-Open No. 2016-68233

### SUMMARY OF THE INVENTION

### Problems to be Solved by the Invention

Depending on the gripping manner, the contact area between the grip unit and the object is small. Also, depending on the material of the object, the friction coefficient is small, and the object is slippery. Therefore, even in a case where objects having the same weight are moved, it might be better to change the moving manner for each object.

The present technology has been made in view of such circumstances, and aims to enable a predetermined motion while a gripped object is stabilized.

### Solutions to Problems

A control device according to one aspect of the present technology includes: a detection unit that detects a gripped state of an object gripped by a hand unit; and a control unit that limits motion of a motion unit while the object is gripped by the hand unit, in accordance with a result of the detection of the gripped state.

In one aspect of the present technology, a gripped state of an object gripped by a hand unit is detected, and motion of a motion unit while the object is gripped by the hand unit is limited in accordance with a result of the detection of the gripped state.

### BRIEF DESCRIPTION OF DRAWINGS

FIG. 1 is a diagram showing an example configuration of the external appearance of a robot according to an embodiment of the present technology.

FIG. 2 is an enlarged view of a hand unit.

FIG. 3 is a diagram illustrating an example of control on the robot.

FIG. 4 is a block diagram showing an example configuration of the hardware of the robot.

FIG. 5 is a block diagram showing an example configuration of an arm unit.

FIG. 6 is a block diagram showing an example configuration of the hand unit.

FIG. 7 is a diagram showing an example configuration of a surface of a pressure distribution sensor.

FIG. 8 is a diagram showing an example configuration of a control system.

FIG. 9 is a block diagram showing an example functional configuration of a control device.

FIG. 10 is a block diagram showing an example configuration of a gripped-state detection unit shown in FIG. 9.

FIG. 11 is a block diagram showing an example configuration of an action control unit shown in FIG. 9.

FIG. 12 is a block diagram showing another example configuration of the action control unit shown in FIG. 9.

FIG. 13 is a flowchart showing an action control process to be performed by the control device.

FIG. 14 is a flowchart for explaining a motion limit value determination process to be performed in step S5 in FIG. 13.

FIG. 15 is a block diagram showing an example configuration of the gripped-state detection unit.

FIG. 16 is a block diagram showing another example configuration of the gripped-state detection unit.

FIG. 17 is a block diagram showing an example configuration of a control device including a learning device.

FIG. 18 is a flowchart for explaining a learning process to be performed by the control device.

FIG. 19 is a block diagram showing another example configuration of the control device including a learning device.

FIG. 20 is a block diagram showing another example configuration of the gripped-state detection unit.

FIG. 21 is a block diagram showing an example configuration of a control device.

FIG. 22 is a block diagram showing an example configuration of a computer.

### MODES FOR CARRYING OUT THE INVENTION

The following is a description of modes for carrying out the present technology. Explanation will be made in the following order.

1. Gripping function of a robot

2. Configuration of a robot

3. Operation of a control device

4. Examples using a neural network

5. Examples of learning

6. Modifications

<Gripping Function of a Robot>

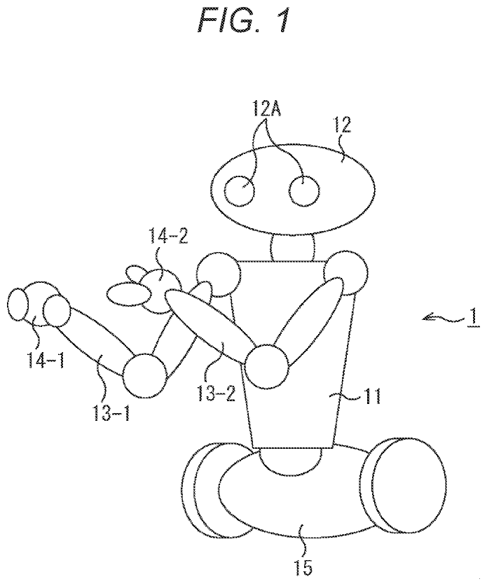

FIG. 1 is a diagram showing an example configuration of the external appearance of a robot according to an embodiment of the present technology.

As shown in FIG. 1, a robot 1 is a robot that has a humanoid upper body and a movement mechanism using wheels. A head unit 12 in the form of a flattened spherical object is provided on a trunk unit 11. On the front face of the head unit 12, two cameras 12A are provided to imitate human eyes.

At the upper end of the trunk unit 11, arm units 13-1 and 13-2 formed with manipulators having multiple degrees of freedom are provided. Hand units 14-1 and 14-2 are provided at the ends of the arm units 13-1 and 13-2, respectively. The robot 1 has a function of gripping an object with the hand units 14-1 and 14-2.

Hereinafter, in a case where there is no need to distinguish the arm units 13-1 and 13-2 from each other, they will be collectively referred to as the arm unit 13, as appropriate. Also, in a case where there is no need to distinguish the hand units 14-1 and 14-2 from each other, they will be collectively referred to as the hand unit 14. The other components provided in pairs will also be collectively described as appropriate.

A trolley-like mobile unit 15 is provided at the lower end of the trunk unit 11. The robot 1 can move by rotating the wheels provided to the right and left of the mobile unit 15 and changing the orientation of the wheels.

As described above, the robot 1 is a robot capable of performing an operation in which the whole body is coordinated, such as freely lifting or transporting an object in a three-dimensional space while gripping the object with the hand unit 14.

The robot 1 may be designed as a single-arm robot (having only one hand of the hand unit 14), instead of a two-arm robot as shown in FIG. 1. Further, the trunk unit 11 may be provided on the leg unit, instead of on the trolley (the mobile unit 15).

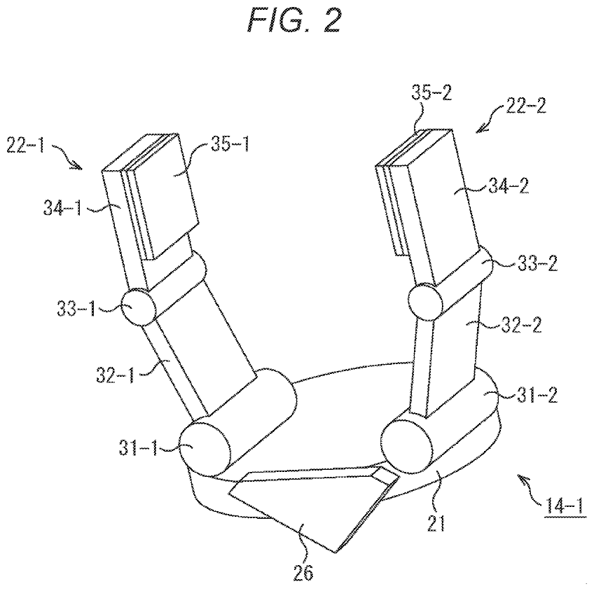

FIG. 2 is an enlarged view of the hand unit 14-1.

As shown in FIG. 2, the hand unit 14-1 is a gripper-type grip unit with two fingers. Finger units 22-1 and 22-2 forming two finger units 22 on the outer and inner sides are attached to a base unit 21.

The finger unit 22-1 is connected to the base unit 21 via a joint portion 31-1. A plate-like portion 32-1 having a predetermined width is attached to the joint portion 31-1, and a joint portion 33-1 is attached to the end of the plate-like portion 32-1. A plate-like portion 34-1 is attached to the end of the joint portion 33-1. The cylindrical joint portions 31-1 and 33-1 have a predetermined range of motion.

The finger unit 22-2 has a configuration similar to that of the finger unit 22-1. That is, a plate-like portion 32-2 having a predetermined width is attached to a joint portion 31-2, and a joint portion 33-2 is attached to the end of the plate-like portion 32-2. A plate-like portion 34-2 is attached to the end of the joint portion 33-2. The cylindrical joint portions 31-2 and 33-2 have a predetermined range of motion.

The respective joint portions are moved, so that the finger units 22-1 and 22-2 are opened and closed. An object is nipped between the inner side of the plate-like portion 34-1 attached to the end of the finger unit 22-1 and the inside side of the plate-like portion 34-2 attached to the end of the finger unit 22-2. Thus, the object is gripped.

As shown in FIG. 2, a thin plate-like pressure distribution sensor 35-1 is provided on the inner side of the plate-like portion 34-1 of the finger unit 22-1. Also, a thin plate-like pressure distribution sensor 35-2 is provided on the inner side of the plate-like portion 34-2 of the finger unit 22-2.

In a case where an object is being gripped, a pressure distribution sensor 35 (the pressure distribution sensors 35-1 and 35-2) measures the distribution of pressure on the contact surfaces between the hand unit 14 and the object. The gripped state of the object is observed, on the basis of the distribution of pressure on the surfaces in contact with the object.

An inertial measurement unit (IMU) 36 that is a sensor for measuring angular velocity and acceleration using inertia is provided at a position on the root of the hand unit 14-1. The state of motion and the disturbance caused when the object is moved as the arm unit 13 is moved or the like are observed on the basis of the angular velocity and the acceleration measured by the IMU 36. The disturbance includes vibration during transportation and the like.

The same configuration as the configuration of the hand unit 14-1 as described above is also provided for the hand unit 14-2.

Although the hand unit 14 is a two-finger grip unit in the above example, multi-finger grip units having different numbers of finger units, such as a three-finger grip unit and a five-finger grip unit, may also be adopted.

As described above, in a case where the robot 1 is gripping an object, the robot 1 can estimate the gripped state of the object, on the basis of the pressure distribution measured by the pressure distribution sensor 35 provided in the hand unit 14. The gripped state is represented by the friction coefficient of the contact surfaces between the hand unit 14 (the pressure distribution sensor 35) and the object, the slipperiness of the contact surfaces, and the like.

Further, in a case where the robot 1 is moving an object by operating the arm unit 13, or is moving by operating the mobile unit 15, while gripping the object, the robot 1 can estimate the state of motion and the disturbance, on the basis of a result of measurement performed by the IMU 36 provided in the hand unit 14. From the result of the measurement performed by the IMU 36, the velocity and the acceleration of the gripped object are estimated.

The gripped state of the object may be estimated by combining a result of measurement performed by the pressure distribution sensor 35 and a result of measurement performed by the IMU 36.

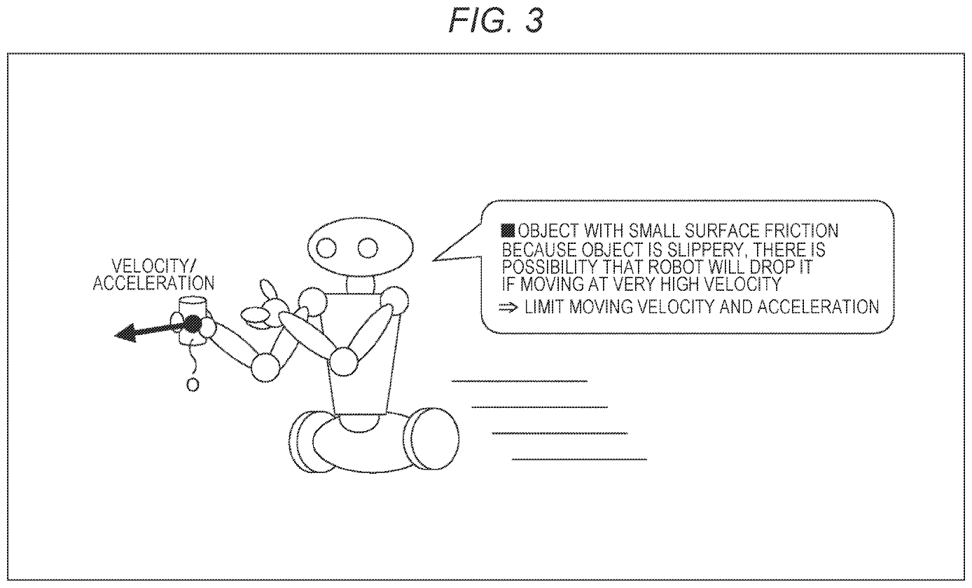

FIG. 3 is a diagram illustrating an example of control of the robot 1.

As shown in FIG. 3, the robot 1 may be moving while gripping an object O with the hand unit 14-1. In the robot 1, the gripped state of the object O is estimated, and the state of a moving operation and the disturbance at the time of the movement are also estimated.

For example, in a case where it is determined that the friction coefficient of the contact surfaces between the hand unit 14-1 and the object O is low, and the gripped state is not preferable, control to limit motion of the arm unit 13 and the mobile unit 15, which are the other motion units, is performed so as to reduce the velocity v and the acceleration a to be generated in the object O.

That is, in a case where the gripped state is poor due to slipperiness of the object, there is a possibility that the object O will be dropped if moved (transported) at a high velocity. In a case where the gripped state is poor, motion of the whole body such as the arm unit 13 and the mobile unit 15, which are different motion units from the hand unit 14, is limited, so that the object O can be prevented from being dropped.

In this manner, the robot 1 has a function of estimating the stability and the like of the object O on the basis of the tactile sense obtained by the pressure distribution sensor 35 and the vibration sense obtained by the IMU 36, and limiting motion of the whole body as appropriate.

Accordingly, in a case where the whole body is moved depending on a task such as lifting and moving an object or transporting an object, the whole body can be moved while the object is stabilized.

Further, since the control described above is performed on the basis of results of measurement while the object is actually gripped, motion of the whole body can be controlled even in a case where information about the gripped object (such as the shape, the weight, and the friction coefficient thereof) has not been provided in advance.

<Configuration of a Robot>

Hardware Configuration

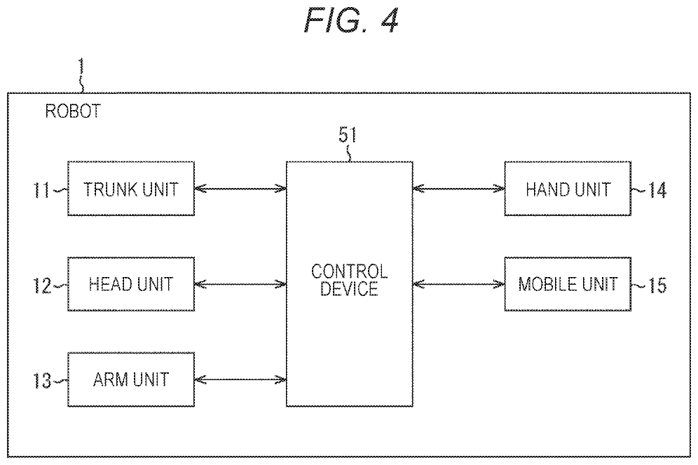

FIG. 4 is a block diagram showing an example configuration of the hardware of the robot 1.

As shown in FIG. 4, the robot 1 is formed by connecting the respective components included in the trunk unit 11, the head unit 12, the arm unit 13, the hand unit 14, and the mobile unit 15, to a control device 51.

The control device 51 is formed with a computer that includes a central processing unit (CPU), a read only memory (ROM), a random access memory (RAM), and a flash memory. The control device 51 is housed in the trunk unit 11, for example. The control device 51 executes a predetermined program with the CPU, to control motion of the entire robot 1.

The control device 51 recognizes the environments surrounding the robot 1 on the basis of results of measurement performed by sensors, images captured by cameras, and the like, and makes an action plan according to a result of the recognition. Various kinds of sensors and cameras are provided in the respective units that are the trunk unit 11, the head unit 12, the arm unit 13, the hand unit 14, and the mobile unit 15.

The control device 51 generates a task for realizing a predetermined action, and conducts whole body motion on the basis of the generated task. For example, an operation of moving an object by moving the arm unit 13 while gripping the object, or an operation of transporting an object by moving the mobile unit 15 while gripping the object is performed as the whole body motion.

Further, the control device 51 also performs processing such as limiting motion of each component to realize the whole body motion, in accordance with the gripped state of the object, as described above.

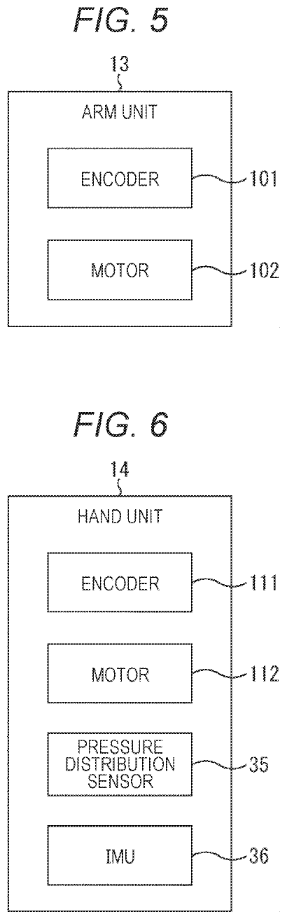

FIG. 5 is a block diagram showing an example configuration of the arm unit 13.

The arm unit 13 includes an encoder 101 and a motor 102. A combination of the encoder 101 and the motor 102 is provided for each of the joints constituting the arm unit 13.

The encoder 101 detects the amount of rotation of the motor 102, and outputs a signal indicating the rotation amount to the control device 51.

The motor 102 rotates about the axis of a joint. The speed of rotation, the amount of rotation, and the like of the motor 102 are controlled by the control device 51.

In addition to the encoder 101 and the motor 102, components such as a sensor and a camera are provided in the arm unit 13.

The head unit 12 and the mobile unit 15 also have a configuration similar to the configuration shown in FIG. 5. The number of combinations of the encoder 101 and the motor 102 is the number corresponding to the number of joints provided in the head unit 12 and the mobile unit 15. In the description below, the configuration of the arm unit 13 shown in FIG. 5 will be used as the configurations of the head unit 12 and the mobile unit 15 as appropriate.

FIG. 6 is a block diagram showing an example configuration of the hand unit 14.

In FIG. 6, the same components as those described above are denoted by the same reference numerals as those used above. The explanations that have already been made will not be repeated below.

The hand unit 14 includes an encoder 111 and a motor 112, in addition to the pressure distribution sensor 35 and the IMU 36. A combination of the encoder 111 and the motor 112 is provided for each of the joints constituting the finger units 22 (FIG. 2).

The encoder 111 detects the amount of rotation of the motor 112, and outputs a signal indicating the rotation amount to the control device 51.

The motor 112 rotates about the axis of a joint. The speed of rotation, the amount of rotation, and the like of the motor 112 are controlled by the control device 51. When the motor 112 operates, an object is gripped.

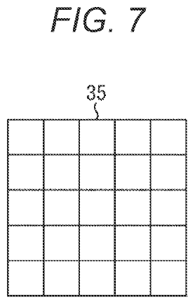

FIG. 7 is a diagram showing an example configuration of a surface of the pressure distribution sensor 35.

As shown in FIG. 7, a surface of the pressure distribution sensor 35 that has a substantially square shape is divided into a plurality of rectangular sections. In a case where an object is gripped by the hand unit 14, the pressure for each section is detected, for example, and the distribution of pressure on the entire surface is measured, on the basis of the detected values of the pressure in the respective sections.

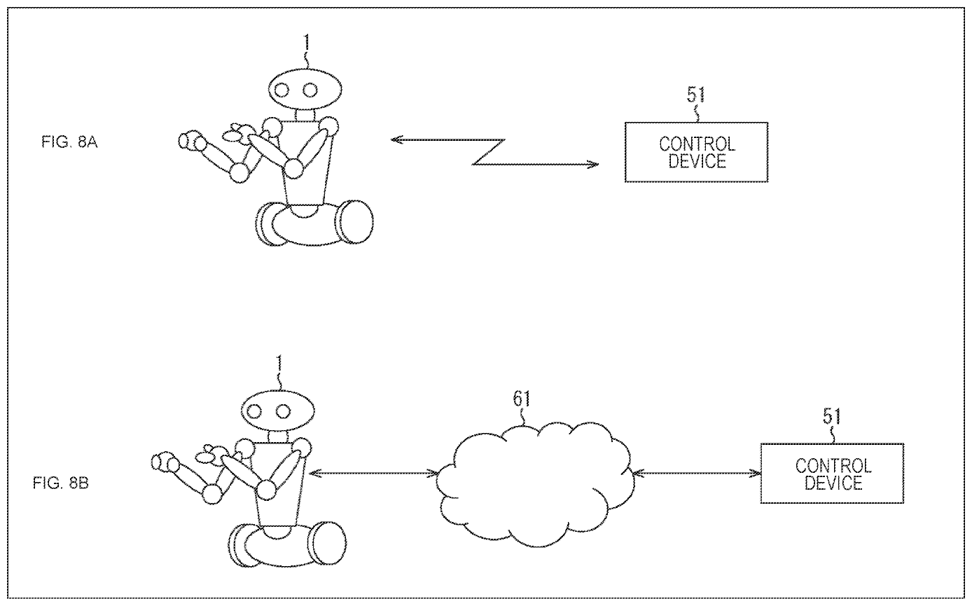

FIG. 8 is a diagram showing an example configuration of a control system.

The control system shown in FIG. 8 is formed by providing the control device 51 as a device outside the robot 1. In this manner, the control device 51 may be provided outside the housing of the robot 1.

Wireless communication of a predetermined standard such as a wireless LAN or Long Term Evolution (LTE) is performed between the robot 1 and the control device 51 in FIG. 8.

Various kinds of information such as information indicating the state of the robot 1 and information indicating results of measurement performed by sensors are transmitted from the robot 1 to the control device 51. Information for controlling action of the robot 1 and the like are transmitted from the control device 51 to the robot 1.

The robot 1 and the control device 51 may be connected directly to each other as shown in A of FIG. 8, or may be connected via a network 61 such as the Internet as shown in B of FIG. 8. Motion of a plurality of robots 1 may be controlled by one control device 51.

Functional Configuration

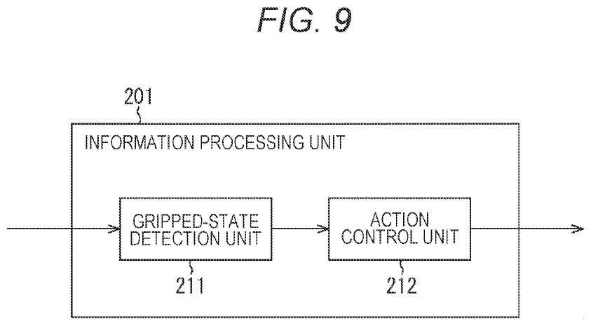

FIG. 9 is a block diagram showing an example functional configuration of the control device 51.

At least one of the functional units shown in FIG. 9 is realized by the CPU of the control device 51 executing a predetermined program.

As shown in FIG. 9, an information processing unit 201 is formed in the control device 51. The information processing unit 201 includes a gripped-state detection unit 211 and an action control unit 212. Pressure distribution information indicating a result of measurement performed by the pressure distribution sensor 35, and IMU information indicating a result of measurement performed by the IMU 36 are input to the gripped-state detection unit 211.

The gripped-state detection unit 211 calculates grip stability serving as an index of stability of the object gripped by the hand unit 14, on the basis of the pressure distribution information and the IMU information. On the basis of the grip stability, the gripped-state detection unit 211 also determines motion limit values to be used for limiting the motion of the whole body including the arm unit 13 and the mobile unit 15, and then outputs the motion limit value to the action control unit 212.

The action control unit 212 controls motion of the whole body including the arm unit 13 and the mobile unit 15, in accordance with a task for realizing a predetermined action. The control by the action control unit 212 is performed as appropriate so as to limit the trajectory of motion of the whole body and torque, on the basis of the motion limit values determined by the gripped-state detection unit 211.

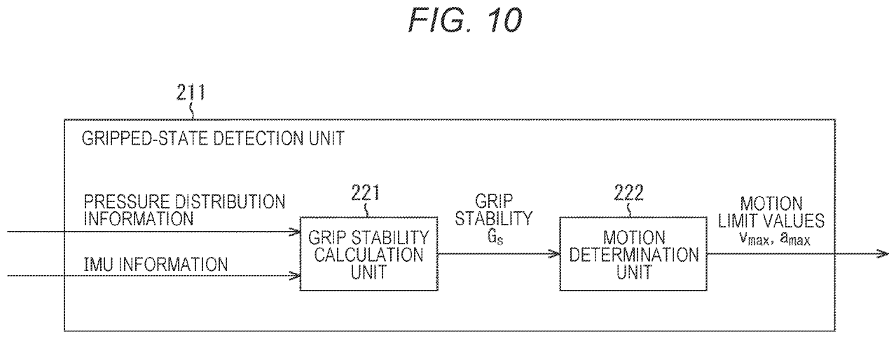

FIG. 10 is a block diagram showing an example configuration of the gripped-state detection unit 211 shown in FIG. 9.

As shown in FIG. 10, the gripped-state detection unit 211 includes a grip stability calculation unit 221 and a motion determination unit 222. The pressure distribution information and the IMU information are input to the grip stability calculation unit 221.

The grip stability calculation unit 221 performs predetermined calculation on the basis of the pressure distribution information and the IMU information, to calculate a grip stability G_{S}. The more stable the object gripped by the hand unit 14, the greater the value calculated as the value of the grip stability G_{S}.

Information indicating the relationship between the grip stability G_{S}, and the pressure distribution information and the IMU information is set beforehand in the grip stability calculation unit 221. The grip stability calculation unit 221 outputs information indicating the grip stability G_{S} calculated from the preset information, to the motion determination unit 222.

On the basis of the grip stability G_{S} calculated by the grip stability calculation unit 221, the motion determination unit 222 determines a maximum velocity value vₘₐₓ and a maximum acceleration value aₘₐₓ, which serve as the motion limit values. The maximum velocity value vₘₐₓ and the maximum acceleration value aₘₐₓ are set as values at which object gripping is predicted to be successful in a case where the velocity and the acceleration of the object gripped by the hand unit 14 are such a velocity and acceleration that do not exceed the values, for example.

Where the object gripped by the hand unit 14 is stable, and the grip stability G_{S} is high, great values are calculated as the maximum velocity value vₘₐₓ and the maximum acceleration value aₘₐₓ. Conversely, where the object gripped by the hand unit 14 is instable, and the grip stability G_{S} is low, small values are calculated as the maximum velocity value vₘₐₓ and the maximum acceleration value aₘₐₓ.

Information indicating the relationship between the grip stability G_{S}, and the maximum velocity value vₘₐₓ and the maximum acceleration value aₘₐₓ is set beforehand in the motion determination unit 222. The motion determination unit 222 outputs information indicating the maximum velocity value vₘₐₓ and the maximum acceleration value aₘₐₓ calculated from the preset information. The information output from the motion determination unit 222 is supplied to the action control unit 212.

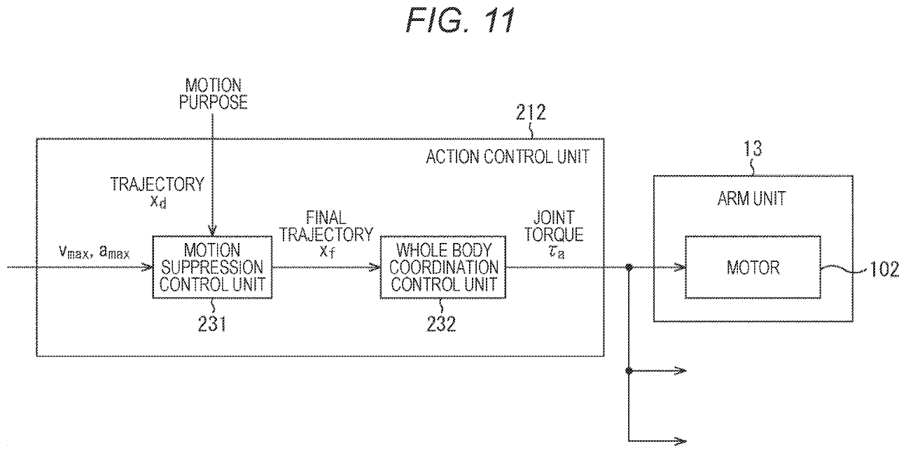

FIG. 11 is a block diagram showing an example configuration of the action control unit 212 shown in FIG. 9.

As shown in FIG. 11, the action control unit 212 includes a motion suppression control unit 231 and a whole body coordination control unit 232. The information indicating the maximum velocity value vₘₐₓ and the maximum acceleration value aₘₐₓ output from the gripped-state detection unit 211 is input to the motion suppression control unit 231. Information indicating a trajectory x_{d} corresponding to a motion purpose is also input to the motion suppression control unit 231.

The motion purpose is the content of the motion required by a predetermined task. For example, an instruction to lift an object up, transport an object, or the like corresponds to the motion purpose. On the basis of the motion purpose, the trajectory x_{d} representing the path of each component to be actually moved is calculated. The trajectory x_{d} is calculated for each of the components to be moved, such as the arm unit 13 and the mobile unit 15.

The motion suppression control unit 231 corrects the trajectory x_{d} on the basis of the maximum velocity value vₘₐₓ and the maximum acceleration value aₘₐₓ, which are the motion limit values, and calculates the final trajectory x_{f}. The final trajectory x_{f} is calculated according to Expression (1) shown below, for example.

[Mathematical Expression 1]

X_{f}=X_{d}−X_{|im}(Vₘₐₓ,aₘₐₓ) (1)

That is, the final trajectory x_{f} is calculated by subtracting a suppression trajectory amount xₗᵢₘ corresponding to the gripped state from the original trajectory x_{d} for realizing the motion.

In Expression (1) shown above, the suppression trajectory amount xₗᵢₘ is a value calculated on the basis of the maximum velocity value vₘₐₓ and the maximum acceleration value aₘₐₓ.

For example, the greater the maximum velocity value vₘₐₓ and the maximum acceleration value aₘₐₓ, the smaller the value calculated as the value of the suppression trajectory amount xₗᵢₘ. In this case, the final trajectory x_{f} is calculated, with the degree of limitation being lowered. Conversely, the smaller the maximum velocity value vₘₐₓ and the maximum acceleration value aₘₐₓ, the greater the value calculated as the value of the suppression trajectory amount xₗᵢₘ. In this case, the final trajectory x_{f} is calculated in such a manner as to limit the trajectory x_{d} more strictly.

As the original trajectory x_{d} is corrected by the subtraction of the suppression trajectory amount xₗᵢₘ, it is possible to prevent motion that might generate an excessive velocity or acceleration.

The motion suppression control unit 231 outputs information indicating the final trajectory x_{f} calculated as described above, to the whole body coordination control unit 232.

On the basis of the final trajectory x_{f} indicated by the information supplied from the motion suppression control unit 231, the whole body coordination control unit 232 calculates the torque value τₐ of each of the joints necessary for realizing the motion according to the final trajectory x_{f}. The whole body coordination control unit 232 outputs information indicating the torque value τₐ to each of the components to be moved.

For example, in a case where the arm unit 13 is to be moved, driving of the motor 102 is controlled on the basis of the torque value τₐ supplied from the whole body coordination control unit 232.

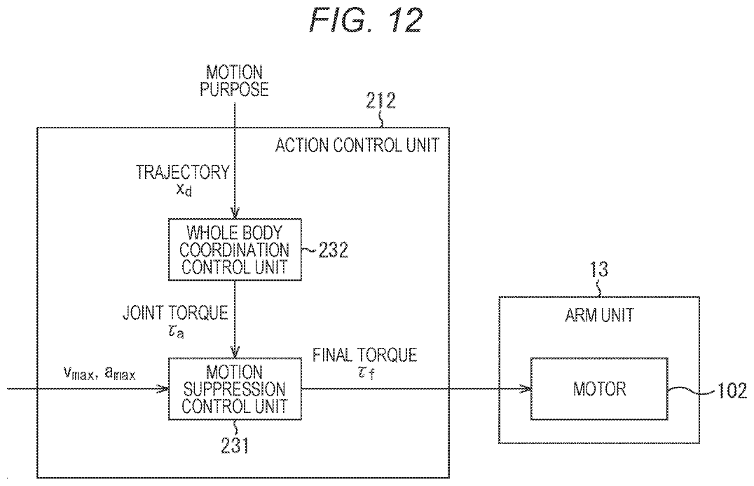

FIG. 12 is a block diagram showing another example configuration of the action control unit 212 shown in FIG. 9.

In the example shown in FIG. 11, the trajectory x_{d} corresponding to the motion purpose is corrected on the basis of the maximum velocity value vₘₐₓ and the maximum acceleration value aₘₐₓ. In the example shown in FIG. 12, on the other hand, the torque value τₐ is corrected on the basis of the maximum velocity value vₘₐₓ and the maximum acceleration value aₘₐₓ.

As shown in FIG. 12, the information indicating the maximum velocity value vₘₐₓ and the maximum acceleration value aₘₐₓ output from the gripped-state detection unit 211 is input to the motion suppression control unit 231. The information indicating the trajectory x_{d} corresponding to the motion purpose is input to the whole body coordination control unit 232.

On the basis of the trajectory x_{d} corresponding to the motion purpose, the whole body coordination control unit 232 calculates the torque value τₐ of each of the joints necessary for realizing the motion corresponding to the trajectory x_{d}. The whole body coordination control unit 232 outputs information indicating the torque value τₐ to the motion suppression control unit 231.

The motion suppression control unit 231 corrects the torque value τₐ on the basis of the maximum velocity value vₘₐₓ and the maximum acceleration value aₘₐₓ, which are the motion limit values, and calculates the final torque value τ_{f}. The final torque value τ_{f} is calculated according to Expression (2) shown below, for example.

[Mathematical Expression 2]

τ_{f}=τₐ−τ_{|im}(Vₘₐₓ,aₘₐₓ) (2)

That is, the final torque value τ_{f} is calculated by subtracting a suppression torque amount Tim corresponding to the gripped state from the original torque value τₐ for realizing the motion corresponding to the trajectory x_{d}.

In Expression (2) shown above, the suppression torque amount τₗᵢₘ is a value calculated on the basis of the maximum velocity value vₘₐₓ and the maximum acceleration value aₘₐₓ.

For example, the greater the maximum velocity value vₘₐₓ and the maximum acceleration value aₘₐₓ, the smaller the value calculated as the value of the suppression torque amount Tₗᵢₘ. In this case, the final torque value τ_{f} is calculated, with the degree of limitation being lowered. Conversely, the smaller the maximum velocity value vₘₐₓ and the maximum acceleration value aₘₐₓ, the greater the value calculated as the value of the suppression torque amount τₗᵢₘ. In this case, the final torque value τ_{f} is calculated in such a manner as to limit the torque value τₐ more strictly.

As the original torque value τₐ is corrected by the subtraction of the suppression torque amount Tₗᵢₘ, it is possible to prevent motion that might generate an excessive velocity or acceleration.

Motion of each component may not be limited on the basis of both the maximum velocity value vₘₐₓ and the maximum acceleration value aₘₐₓ, but motion of each component may be limited on the basis of the maximum velocity value vₘₐₓ or the maximum acceleration value aₘₐₓ.

<Operation of the Control Device>

Operation of the control device 51 having the above configuration is now described.

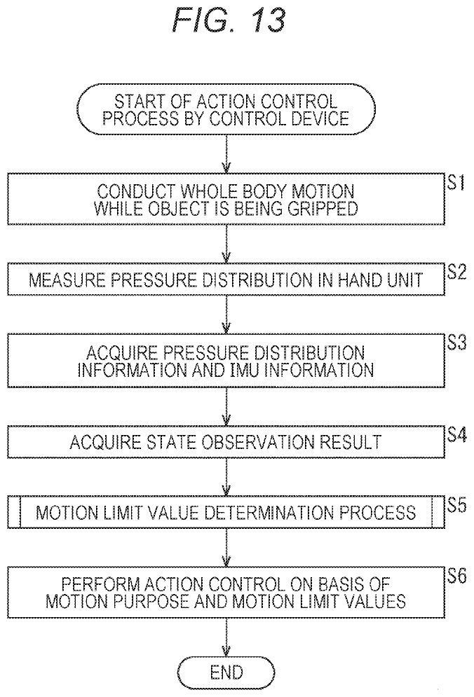

Referring to a flowchart shown in FIG. 13, an action control process to be performed by the control device 51 is described.

In step S1, the action control unit 212 controls the respective components, and conducts whole body motion while an object is gripped. As the whole body motion is started, measurement by the IMU 36 is started, and IMU information indicating a result of the measurement performed by the IMU 36 is output to the grip stability calculation unit 221.

In step S2, the pressure distribution sensor 35 measures the pressure distribution on the contact surfaces between the hand unit 14 and the object. Pressure distribution information indicating a result of the measurement performed by the pressure distribution sensor 35 is output to the grip stability calculation unit 221.

In step S3, the grip stability calculation unit 221 of the gripped-state detection unit 211 acquires the pressure distribution information supplied from the pressure distribution sensor 35 and the IMU information supplied from the IMU 36.

In step S4, the grip stability calculation unit 221 acquires a result of observation of the state of the robot 1. For example, the state of the robot 1 is indicated by a result of analysis of images captured by cameras, a result of analysis of sensor data measured by various sensors, and the like.

In this manner, a result of observation of the state of the robot 1 can also be used in the grip stability calculation by the grip stability calculation unit 221.

In step S5, a motion limit value determination process is performed by the gripped-state detection unit 211. The motion limit value determination process is a process of calculating the grip stability on the basis of the pressure distribution information and the IMU information, and determining the motion limit values on the basis of the grip stability.

In step S6, the action control unit 212 controls each component on the basis of the motion purpose and the motion limit values determined by the motion limit value determination process, and conducts whole body motion to take a predetermined action.

While a predetermined task is generated by an action planning unit (not shown) or the like, and an instruction to conduct whole body motion while an object is gripped is valid, the process described so far is repeated.

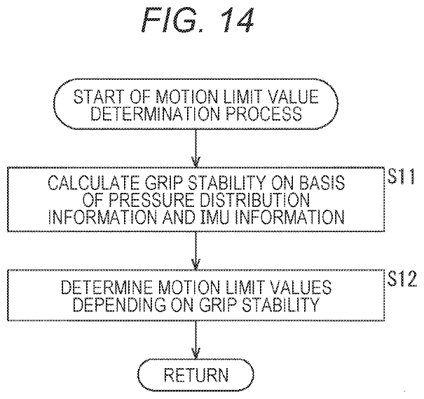

Next, the motion limit value determination process to be performed in step S5 in FIG. 13 is described, with reference to a flowchart in FIG. 14.

In step S11, the grip stability calculation unit 221 calculates the grip stability G_{S} on the basis of the pressure distribution information and the IMU information.

In step S12, the motion determination unit 222 determines motion limit values including the maximum velocity value vₘₐₓ and the maximum acceleration value aₘₐₓ, in accordance with the grip stability G_{S} calculated by the grip stability calculation unit 221.

After that, the process returns to step S5 in FIG. 13, and the process thereafter is performed.

In a case where the whole body is moved depending on a task such as lifting and moving an object or transporting an object, the whole body motion can be realized by the above process while the object is stabilized.

For example, in a case where a slippery object or a heavy object is gripped, it is possible to lift up or transport the object without dropping it.

Also, in a case where a gripped container contains liquid or the like, it is possible to lift up or transport the container without dropping it.

Whether or not liquid is contained in a gripped object may be estimated as a result of observation of the state of the robot 1 through analysis of images captured by the cameras 12A, for example. In this case, as well as whether or not liquid is contained in the gripped object, the viscosity of the liquid, the amount of the liquid, and the like can be estimated, and the grip stability can be calculated on the basis of the results of the estimation.

<Examples Using a Neural Network>

The grip stability calculation by the grip stability calculation unit 221 may be performed with the use of a neural network (NN), instead of being analytically performed through mechanical calculation.

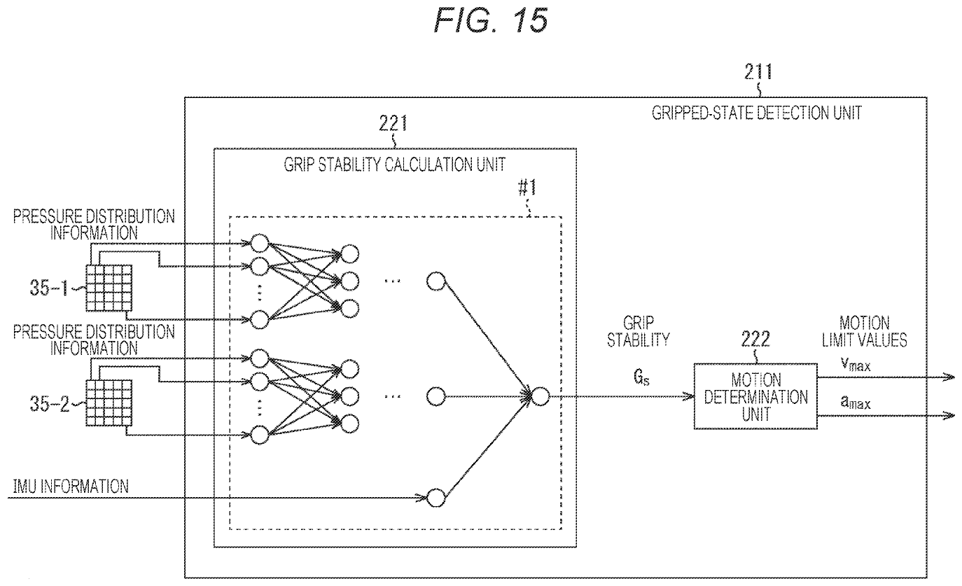

FIG. 15 is a block diagram showing an example configuration of the gripped-state detection unit 211.

In FIG. 15, the same components as those described with reference to FIG. 10 and others are denoted by the same reference numerals as those used in FIG. 10 and others. The explanations that have already been made will not be repeated below.

The grip stability calculation unit 221 shown in FIG. 15 includes a NN #1 surrounded by a dashed line in the drawing. The NN #1 is a NN that receives inputs of the pressure distribution information and the IMU information, and outputs the grip stability G_{S}. The grip stability G_{S} output from the NN #1 of the grip stability calculation unit 221 is supplied to the motion determination unit 222.

On the basis of the grip stability G_{S} output from the NN #1, the motion determination unit 222 determines and outputs the maximum velocity value vₘₐₓ and the maximum acceleration value aₘₐₓ that serve as the motion limit values.

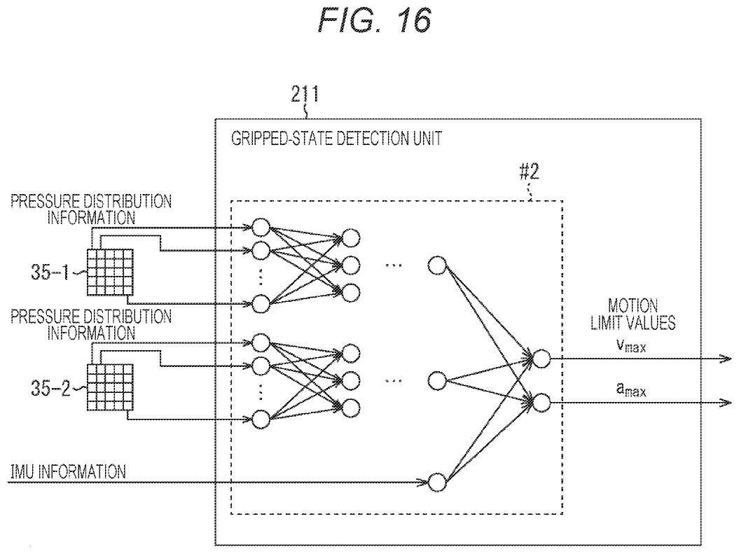

FIG. 16 is a block diagram showing another example configuration of the gripped-state detection unit 211.

The gripped-state detection unit 211 shown in FIG. 16 includes a NN #2. The NN #2 is a NN that receives inputs of the pressure distribution information and the IMU information, and outputs the maximum velocity value vₘₐₓ and the maximum acceleration value aₘₐₓ. That is, in the example shown in FIG. 16, the maximum velocity value vₘₐₓ and the maximum acceleration value aₘₐₓ are detected directly from the pressure distribution information and the IMU information, using NN #2.

In this manner, it is also possible to detect the maximum velocity value vmax and the maximum acceleration value amax with the use of a NN, instead of calculating the grip stability G_{S} with the use of a NN.

<Examples of Learning>

The NN #1 in FIG. 15 and the NN #2 in FIG. 16 are both generated in advance by performing learning using the pressure distribution information and the IMU information, and are used at a time of actual motion (at a time of inference) as described above. Here, learning of a NN including the NN #1 and the NN #2 is described. Reinforcement learning and supervised learning can be used for the learning of a NN.

### Example Using Reinforcement Learning

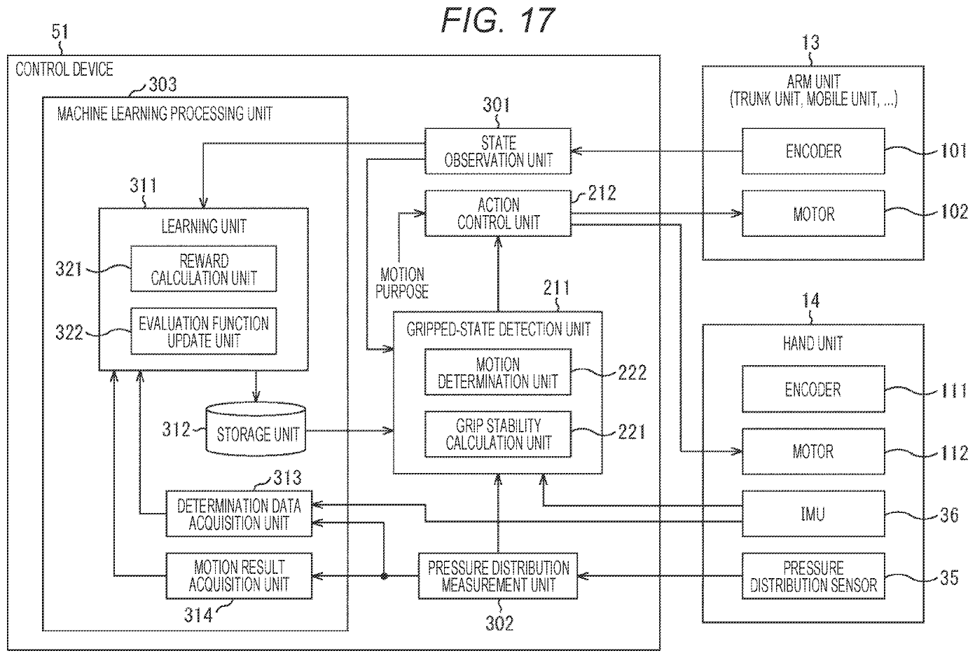

FIG. 17 is a block diagram showing an example configuration of the control device 51 including a learning device.

The control device 51 shown in FIG. 17 includes a state observation unit 301, a pressure distribution measurement unit 302, and a machine learning processing unit 303, in addition to the gripped-state detection unit 211 and the action control unit 212 described above.

The gripped-state detection unit 211 detects a gripped state of an object as described above with reference to FIGS. 15 and 16, on the basis of a NN constructed from information read from a storage unit 312 of the machine learning processing unit 303 at both the learning timing and the inference timing. The pressure distribution information indicating a result of measurement performed by the pressure distribution sensor 35 is supplied from the pressure distribution measurement unit 302 to the gripped-state detection unit 211, and the IMU information is supplied from the IMU 36 to the gripped-state detection unit 211.

The action control unit 212 controls driving of the motor 102 of each of the components such as the trunk unit 11, the arm unit 13, and the mobile unit 15, on the basis of the motion purpose and the motion limit values (the maximum velocity value vₘₐₓ and the maximum acceleration value aₘₐₓ) supplied from the gripped-state detection unit 211 as a result of detection of the gripped state of the object. As described above with reference to FIG. 11, motion of each component is controlled in accordance with the torque value τₐ output from the action control unit 212. Also, as described above with reference to FIG. 12, motion of each component is controlled in accordance with the final torque value τ_{f} output from the action control unit 212.

The action control unit 212 also controls driving of the motor 112 of the hand unit 14 so that an object is gripped.

In this manner, control on each component by the action control unit 212 is performed not only at the time of inference but also at the time of learning. The learning of a NN is performed on the basis of the measurement result obtained when whole body motion is conducted while an object is gripped.

The state observation unit 301 observes the state of the robot 1, on the basis of information and the like supplied from the encoder 101 of each of the components such as the trunk unit 11, the arm unit 13, and the mobile unit 15, at both the time of learning and the time of inference. At the time of learning, the state observation unit 301 outputs a result of observation of the state of the robot 1 to the machine learning processing unit 303.

At the time of inference, the state observation unit 301 also outputs a result of observation of the state of the robot 1 to the gripped-state detection unit 211. In addition to the pressure distribution information and the IMU information, a result of observation of the state of the robot 1 can be used as inputs to the NN #1 and the NN #2.

The pressure distribution measurement unit 302 measures the pressure distribution on the contact surfaces between the hand unit 14 and the object, on the basis of the information supplied from the pressure distribution sensor 35 when the hand unit 14 grips the object, at both the time of learning and the time of inference. At the time of learning, the pressure distribution measurement unit 302 outputs pressure distribution information indicating a result of measurement of the pressure distribution on the contact surfaces between the hand unit 14 and the object, to the machine learning processing unit 303.

At the time of inference, the state observation unit 301 also outputs pressure distribution information indicating a result of measurement of the pressure distribution on the contact surfaces between the hand unit 14 and the object, to the gripped-state detection unit 211.

The machine learning processing unit 303 includes a learning unit 311, a storage unit 312, a determination data acquisition unit 313, and a motion result acquisition unit 314. The learning unit 311 as a learning device includes a reward calculation unit 321 and an evaluation function update unit 322. Each of the components of the machine learning processing unit 303 operates at the time of learning.

The reward calculation unit 321 of the learning unit 311 sets a reward, depending on whether or not gripping an object is successful. The state of the robot 1 observed by the state observation unit 301 is used by the reward calculation unit 321 setting a reward, as appropriate.

The evaluation function update unit 322 updates an evaluation table in accordance with the reward set by the reward calculation unit 321. The evaluation table to be updated by the evaluation function update unit 322 is table information formed with an evaluation function that constructs the NN. The evaluation function update unit 322 outputs and stores information indicating the updated evaluation table, into the storage unit 312.

The storage unit 312 stores the information indicating the evaluation table updated by the evaluation function update unit 322, as parameters constituting the NN. The information stored in the storage unit 312 is read by the gripped-state detection unit 211 as appropriate.

The determination data acquisition unit 313 acquires a measurement result supplied from the pressure distribution measurement unit 302 and a result of measurement performed by the IMU 36. The determination data acquisition unit 313 generates pressure distribution information and IMU information as data for learning, and outputs the pressure distribution information and the IMU information to the learning unit 311.

The motion result acquisition unit 314 determines whether or not the object is successfully gripped, on the basis of the measurement result supplied from the pressure distribution measurement unit 302. The motion result acquisition unit 314 outputs, to the learning unit 311, information indicating a result of determination as to whether or not the object is successfully gripped.

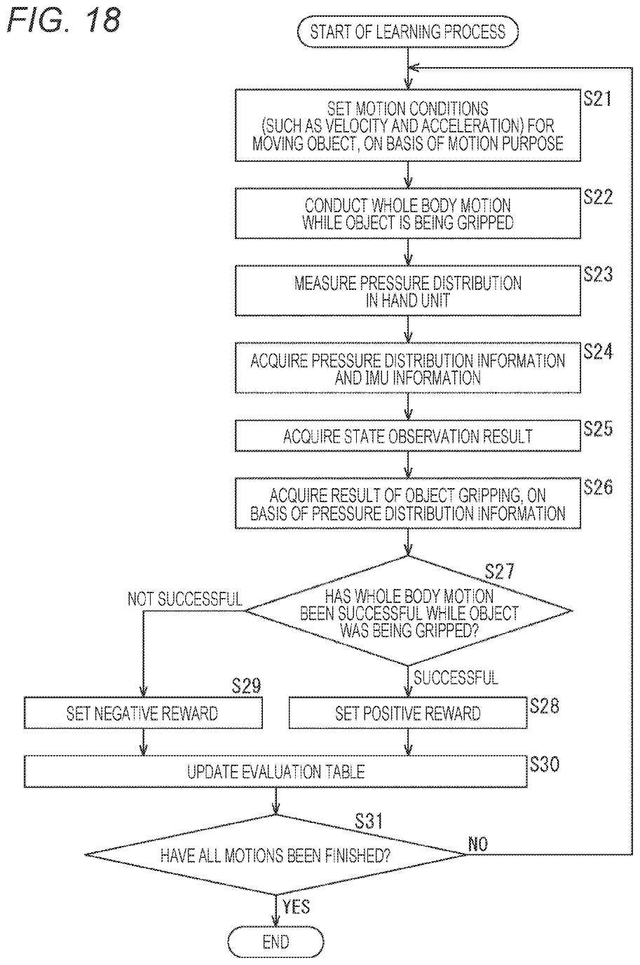

Referring now to a flowchart in FIG. 18, a learning process to be performed by the control device 51 having the configuration described above is described. The process shown in FIG. 18 is a process of generating a NN by reinforcement learning.

In step S21, the action control unit 212 sets motion conditions (velocity and acceleration) for moving an object, on the basis of the motion purpose.

The processes in steps S22 through S25 are similar to the processes in steps S1 through S4 in FIG. 13. That is, in step S22, the action control unit 212 conducts whole body motion while the object is gripped.

In step S23, the pressure distribution sensor 35 measures the pressure distribution in the hand unit 14.

In step S24, the grip stability calculation unit 221 acquires the pressure distribution information and the IMU information.

In step S25, the grip stability calculation unit 221 acquires a state observation result.

In step S26, the reward calculation unit 321 of the learning unit 311 acquires information indicating the determination result output from the motion result acquisition unit 314. On the basis of the measurement result supplied from the pressure distribution measurement unit 302, the motion result acquisition unit 314 determines whether or not the object is successfully gripped, and outputs information indicating the determination result to the learning unit 311.

In step S27, the reward calculation unit 321 determines whether or not the whole body motion while the object is gripped has been successfully conducted, on the basis of the information acquired from the motion result acquisition unit 314.

If it is determined in step S27 that the whole body motion while the object is gripped has been successfully conducted, the reward calculation unit 321 sets a positive reward in step S28.

If it is determined in step S27 that the whole body motion while the object is gripped has failed due to dropping of the object or the like, on the other hand, the reward calculation unit 321 sets a negative reward in step S29.

In step S30, the evaluation function update unit 322 updates the evaluation table in accordance with the reward set by the reward calculation unit 321.

In step S31, the action control unit 212 determines whether or not all the motions have been finished. If it is determined that not all the motions have been finished, the process returns to step S21 and the processes described above are repeated.

If it is determined in step S31 that all the motions have been finished, the learning process comes to an end.

By the reinforcement learning described above, the NN #1 in FIG. 15 that outputs the grip stability G_{S} using the pressure distribution information and the IMU information as inputs, or the NN #2 in FIG. 16 that directly outputs the maximum velocity value vₘₐₓ and the maximum acceleration value aₘₐₓ serving as the motion limit values is generated.

### Example Using Supervised Learning

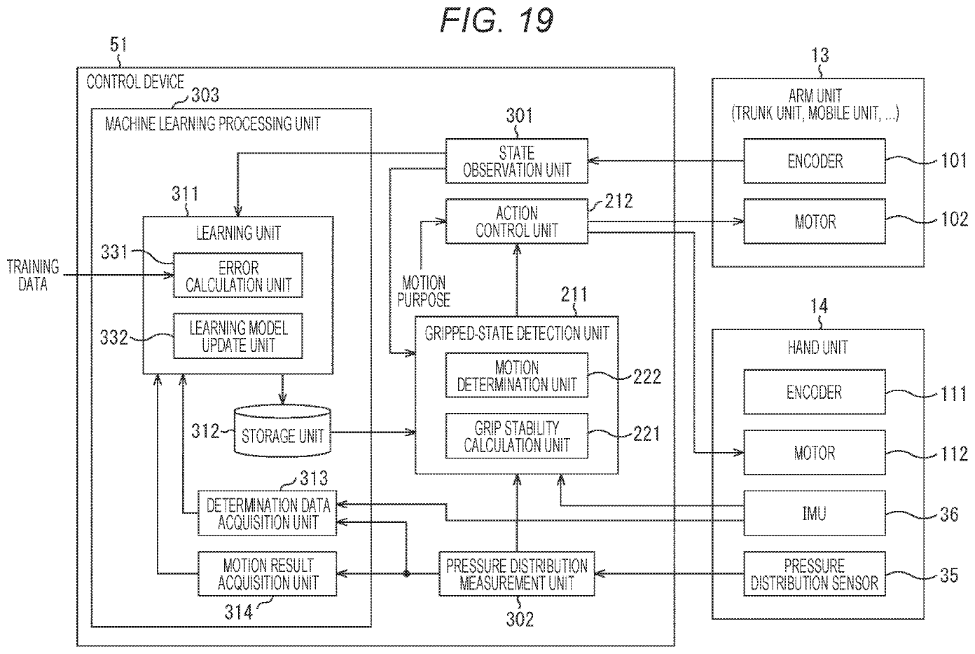

FIG. 19 is a block diagram showing another example configuration of the control device 51 including a learning device.

The configuration of the control device 51 shown in FIG. 19 is the same as the configuration described above with reference to FIG. 17, except for the configuration of the learning unit 311. The explanations that have already been made will not be repeated below.

The learning unit 311 in FIG. 19 includes an error calculation unit 331 and a learning model update unit 332. For example, the pressure distribution information and the IMU information at a time when gripping the object is successful are input as training data to the error calculation unit 331.

The error calculation unit 331 calculates an error from the training data for each set of the pressure distribution information and the IMU information supplied from the determination data acquisition unit 313.

The learning model update unit 332 updates the model, on the basis of the error calculated by the error calculation unit 331. The model is updated by the learning model update unit 332 adjusting the weight of each node so as to reduce the error by a predetermined algorithm such as a backpropagation algorithm. The learning model update unit 332 outputs and stores information indicating the updated model, into the storage unit 312.

As described above, a NN to be used for inference at a time when whole body motion is conducted while an object is gripped can also be generated by supervised learning.

<Modifications>

### Example Using Camera Images

As NN inputs, camera images that are images captured by the cameras 12A may also be used.

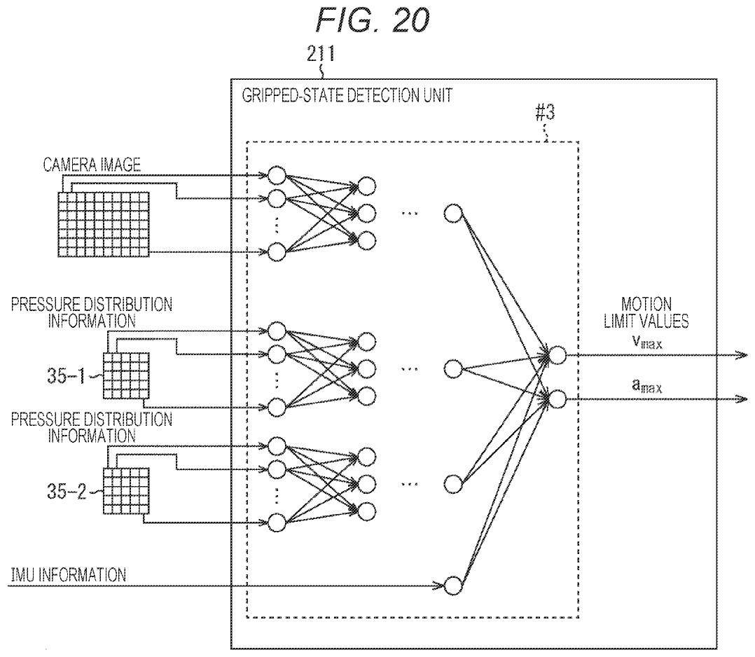

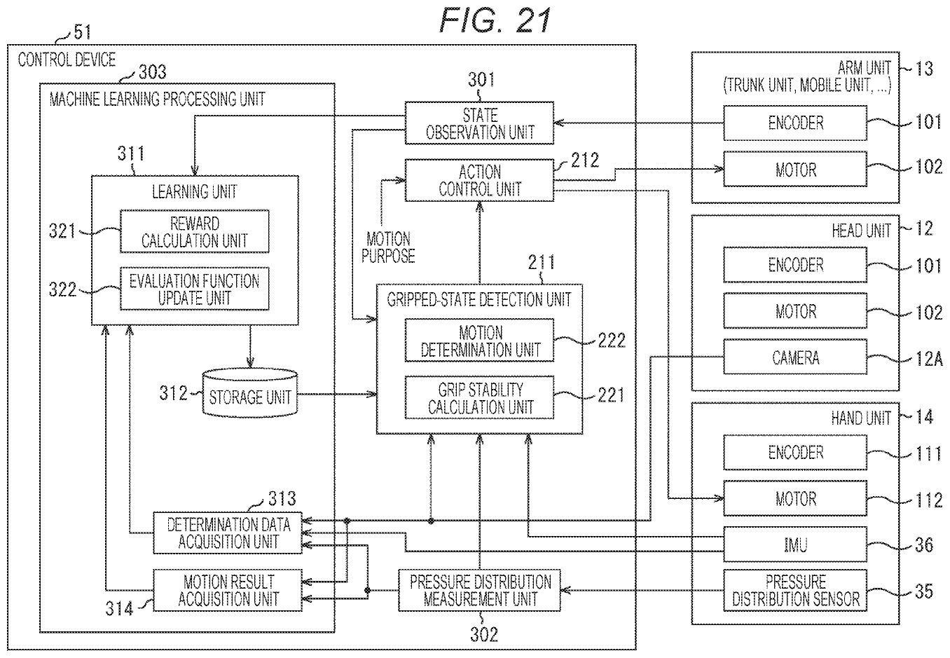

FIG. 20 is a block diagram showing another example configuration of the gripped-state detection unit 211.

The gripped-state detection unit 211 shown in FIG. 20 includes a NN #3. The NN #3 is a NN that receives an input of camera images in addition to the pressure distribution information and the IMU information, and outputs the maximum velocity value vₘₐₓ and the maximum acceleration value aₘₐₓ. That is, data of each of the pixels constituting the camera images captured when an object is gripped by the hand unit 14 is used as an input. The camera images show the object gripped by the hand unit 14.

As the camera images are used, a gripped state of an object that cannot be acquired from the pressure distribution sensor 35 and the IMU 36 can be used for inference. For example, in a case where an object containing liquid or the like is gripped, the state of the liquid level observed from the camera images can be used for inference.

A NN that receives inputs of the pressure distribution information, the IMU information, and camera images, and outputs the grip stability G_{S} may be used, instead of the NN #3.

The learning of the NN #3 shown in FIG. 20 is also performed by reinforcement learning or supervised learning as described above.

FIG. 21 is a block diagram showing an example configuration of the control device 51 in a case where the learning of the NN #3 is performed by reinforcement learning.

The configuration of the control device 51 shown in FIG. 21 differs from the configuration described with reference to FIG. 17 in that camera images captured by the cameras 12A provided on the head unit 12 are input to the determination data acquisition unit 313 and the motion result acquisition unit 314. At the time of inference, the camera images captured by the cameras 12A are also input to the gripped-state detection unit 211.

The determination data acquisition unit 313 in FIG. 21 acquires a measurement result supplied from the pressure distribution measurement unit 302, a result of measurement performed by the IMU 36, and camera images supplied from the cameras 12A. The determination data acquisition unit 313 generates pressure distribution information and IMU information as data for learning, and outputs the pressure distribution information and the IMU information, together with the camera images, to the learning unit 311.

The motion result acquisition unit 314 determines whether or not the object is successfully gripped, on the basis of the measurement result supplied from the pressure distribution measurement unit 302 and the camera images supplied from the cameras 12A. The motion result acquisition unit 314 outputs, to the learning unit 311, information indicating a result of determination as to whether or not the object is successfully gripped.

The learning by the learning unit 311 is performed on the basis of the information supplied from the determination data acquisition unit 313 and the motion result acquisition unit 314.

In this manner, a gripped state of the object can also be detected on the basis of camera images.

### OTHER EXAMPLES OF CONTROL

Although the trajectory x_{d} (FIG. 11) and the torque value τₐ (FIG. 12) are limited on the basis of the pressure distribution information and the IMU information in the above examples, further limitations may be put on them in accordance with the state of the ambient environments, such as the persons or the obstacles that are present in the surroundings. The degree of limitation may also be adjusted in accordance with the specifics of a task such as a motion that puts emphasis on carefulness or a motion that puts emphasis on velocity.

In addition to the limitations on the trajectory x_{d} and the torque value, the posture and method for gripping an object may be changed. For example, in a case where an object is gripped with one hand, when the gripped state of the object is predicted to be unstable even if the trajectory x_{d} is limited, the action plan may be changed to gripping the object with both hands or supporting the object with the other hand too.

Although a case where motion of a robot including a movement mechanism has been described, the functions described above can also be applied in a case where various kinds of motion of a robot not including the movement mechanism are controlled, as long as the robot includes some other motion unit that operates in tandem with motion of the hand unit.

As described above, the robot 1 can have a leg unit. In a case where the robot 1 is designed as a legged mobile unit and has a walking function, it is possible to detect a contact state of the foot portion at the end of the leg unit, and control motion of the whole body including the leg unit in accordance with the state of contact with the ground or the floor. That is, the present technology can be applied to detection of a contact state of the foot portion, instead of a gripped state of the hand unit 14, and control on motion of the whole body so as to stabilize the supported state of the body.

### Example of a Computer

The series of processes described above can be performed by hardware, and can also be performed by software. In a case where the series of processes are performed by software, the program that forms the software may be installed in a computer incorporated into special-purpose hardware, or may be installed from a program recording medium into a general-purpose personal computer or the like.

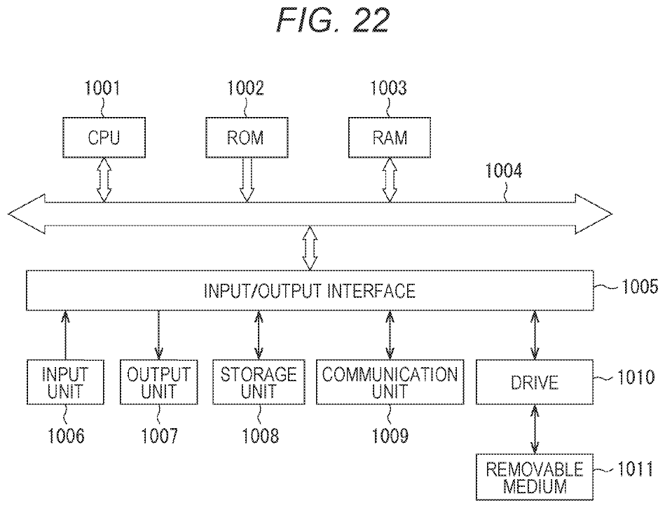

FIG. 22 is a block diagram showing an example configuration of the hardware of a computer that performs the above series of processes according to a program.

A central processing unit (CPU) 1001, a read only memory (ROM) 1002, and a random access memory (RAM) 1003 are connected to one another by a bus 1004.

An input/output interface 1005 is further connected to the bus 1004. An input unit 1006 formed with a keyboard, a mouse, and the like, and an output unit 1007 formed with a display, a speaker, and the like are connected to the input/output interface 1005. Further, a storage unit 1008 formed with a hard disk, a nonvolatile memory, or the like, a communication unit 1009 formed with a network interface or the like, and a drive 1010 that drives a removable medium 1011 are connected to the input/output interface 1005.

In the computer having the above described configuration, the CPU 1001 loads a program stored in the storage unit 1008 into the RAM 1003 via the input/output interface 1005 and the bus 1004, for example, and executes the program, so that the above described series of processes are performed.

The program to be executed by the CPU 1001 is recorded in the removable medium 1011 and is thus provided, for example, or is provided via a wired or wireless transmission medium, such as a local area network, the Internet, or digital broadcasting. The program is then installed into the storage unit 1008.

Note that the program to be executed by the computer may be a program for performing processes in chronological order in accordance with the sequence described in this specification, or may be a program for performing processes in parallel or performing a process when necessary, such as when there is a call.

The advantageous effects described in this specification are merely examples, and the advantageous effects of the present technology are not limited to them or may include other effects.

Embodiments of the present technology are not limited to the embodiments described above, and various modifications may be made to them without departing from the scope of the present technology.

For example, the present technology may be embodied in a cloud computing configuration in which one function is shared among a plurality of devices via a network, and processing is performed by the devices cooperating with one another.

Further, the respective steps described with reference to the flowcharts described above may be carried out by one device or may be shared among a plurality of devices.

Furthermore, in a case where a plurality of processes is included in one step, the plurality of processes included in the one step may be performed by one device or may be shared among a plurality of devices.

### Example Combinations of Configurations

The present technology can also be embodied in the configurations described below.

(1)

A control device including:

a detection unit that detects a gripped state of an object gripped by a hand unit; and

a control unit that limits motion of a motion unit while the object is gripped by the hand unit, in accordance with a result of detection of the gripped state.

(2)

The control device according to (1), in which

the detection unit detects a stability of the object, on the basis of a result of measurement performed by a sensor provided in the hand unit, the stability indicating the gripped state.

(3)

The control device according to (2), in which

the detection unit detects the stability, on the basis of a result of measurement performed by a pressure distribution sensor that measures a distribution of pressure on a contact surface between the hand unit and the object.

(4)

The control device according to (2) or (3), in which

the detection unit detects the stability, on the basis of a result of measurement performed by an inertial sensor provided in the hand unit.

(5)

The control device according to any one of (1) to (4), in which

the control unit limits motion of the motion unit, on the basis of a limit value that is set in accordance with a result of detection of the gripped state.

(6)

The control device according to (5), in which

the control unit limits motion of the motion unit, on the basis of at least one of a velocity limit value and an acceleration limit value at a time of moving the motion unit.

(7)

The control device according to (5) or (6), in which,

on the basis of the limit value, the control unit corrects a trajectory of the motion unit performing a predetermined motion, and controls torque of a motor of the motion unit in accordance with the corrected trajectory.

(8)

The control device according to (5) or (6), in which,

in accordance with the limit value, the control unit corrects torque of a motor of the motion unit depending on a trajectory of the motion unit performing a predetermined motion.

(9)

The control device according to any one of (2) to (8), in which

the detection unit detects the stability, using a neural network that receives an input of a result of measurement performed by the sensor and outputs the stability.

(10)

The control device according to any one of (2) to (8), in which

the detection unit detects the limit value, using a neural network that receives an input of a result of measurement performed by the sensor and outputs a limit value to be used for limiting motion of the motion unit, and

the control unit limits motion of the motion unit, on the basis of the limit value.

(11)

The control device according to (10), further including

a learning unit that learns parameters constituting the neural network.

(12)

The control device according to (11), in which

the learning unit learns the parameters by supervised learning or reinforcement learning using a result of measurement performed by the sensor.

(13)

The control device according to any one of (1) to (12), in which

the detection unit detects the gripped state, on the basis of an image captured by a camera.

(14)

A control method implemented by a control device,

the control method including:

detecting a gripped state of an object gripped by a hand unit; and

limiting motion of a motion unit while the object is gripped by the hand unit, in accordance with a result of detection of the gripped state.

(15)

A program for causing a computer to perform a process of:

detecting a gripped state of an object gripped by a hand unit; and

limiting motion of a motion unit while the object is gripped by the hand unit, in accordance with a result of detection of the gripped state.

### REFERENCE SIGNS LIST

1 Robot
11 Trunk unit
12 Head unit
13-1, 13-2 Arm unit
14-1, 14-2 Hand unit
15 Mobile unit
35-1, 35-2 Pressure distribution sensor
36 IMU
51 Control device
101 Encoder
102 Motor
111 Encoder
112 Motor
201 Information processing unit
211 Gripped-state detection unit
212 Action control unit
221 Grip stability calculation unit
222 Motion determination unit
231 Motion suppression control unit
232 Whole body coordination control unit
301 State observation unit
302 Pressure distribution measurement unit
303 Machine learning processing unit

1. A control device comprising:
a detection unit that detects a gripped state of an object gripped by a hand unit; and
a control unit that limits motion of a motion unit while the object is gripped by the hand unit, in accordance with a result of detection of the gripped state.

2. The control device according to claim 1, wherein
the detection unit detects a stability of the object, on a basis of a result of measurement performed by a sensor provided in the hand unit, the stability indicating the gripped state.

3. The control device according to claim 2, wherein
the detection unit detects the stability, on a basis of a result of measurement performed by a pressure distribution sensor that measures a distribution of pressure on a contact surface between the hand unit and the object.

4. The control device according to claim 2, wherein
the detection unit detects the stability, on a basis of a result of measurement performed by an inertial sensor provided in the hand unit.

5. The control device according to claim 1, wherein
the control unit limits motion of the motion unit, on a basis of a limit value that is set in accordance with a result of detection of the gripped state.

6. The control device according to claim 5, wherein
the control unit limits motion of the motion unit, on a basis of at least one of a velocity limit value and an acceleration limit value at a time of moving the motion unit.

7. The control device according to claim 5, wherein,
on a basis of the limit value, the control unit corrects a trajectory of the motion unit performing a predetermined motion, and controls torque of a motor of the motion unit in accordance with the corrected trajectory.

8. The control device according to claim 5, wherein,
in accordance with the limit value, the control unit corrects torque of a motor of the motion unit depending on a trajectory of the motion unit performing a predetermined motion.

9. The control device according to claim 2, wherein
the detection unit detects the stability, using a neural network that receives an input of a result of measurement performed by the sensor and outputs the stability.

10. The control device according to claim 2, wherein
the detection unit detects the limit value, using a neural network that receives an input of a result of measurement performed by the sensor and outputs a limit value to be used for limiting motion of the motion unit, and
the control unit limits motion of the motion unit, on a basis of the limit value.

11. The control device according to claim 10, further comprising
a learning unit that learns parameters constituting the neural network.

12. The control device according to claim 11, wherein
the learning unit learns the parameters by supervised learning or reinforcement learning using a result of measurement performed by the sensor.

13. The control device according to claim 1, wherein
the detection unit detects the gripped state, on a basis of an image captured by a camera.

14. A control method implemented by a control device,
the control method comprising:
detecting a gripped state of an object gripped by a hand unit; and
limiting motion of a motion unit while the object is gripped by the hand unit, in accordance with a result of detection of the gripped state.

15. A program for causing a computer to perform a process of:
detecting a gripped state of an object gripped by a hand unit; and
limiting motion of a motion unit while the object is gripped by the hand unit, in accordance with a result of detection of the gripped state.
